(19) United States
(12) Patent Application Publication
(10) Pub. No.: US 2024/0289576 A1
(43) Pub. Date: Aug. 29, 2024

(54) Systems and Methods for Generating and Scanning Codes

(71) Applicant: Mohamad Alakkawi, Darmstadt (DE)

(72) Inventor: Mohamad Alakkawi, Darmstadt (DE)

(21) Appl. No.: 18/658,975

(22) Filed: May 8, 2024

Related U.S. Application Data
(63) Continuation of application No. 17/694,664, filed on Mar. 14, 2022, now abandoned.
(60) Provisional application No. 63/137,428, filed on Jan. 14, 2021.

(51) Int. Cl. G06K 7/14

(52) U.S. Cl. CPC G06K 7/1417

(57) ABSTRACT

A system and method enables computerized devices to scan the screens of their own device or to scan the screens of other devices with or without using a camera by a trigger using one or multiple methods. The system provides methods for scanning from a screen of a computerized device or a digital camera. The system provides a method that reduces the required details and size to scan a QR code or any other scannable element directly from the screen or by input into a scanning system. The system provides a method to scan single or multiple QR codes, barcodes, or any other scannable and identifiable elements singular or combined by one or multiple triggers.

### CROSS-REFERENCE TO RELATED APPLICATIONS

This is a Continuation Nonprovisional U.S. Patent Application under 35 U.S.C. 111. This application claims the benefit of the earlier filing date of Nonprovisional U.S. patent application Ser. No. 17,694,664, and Provisional U.S. Patent Application Ser. No. 63/137,428, filed Jan. 14, 2021, titled “Systems and Methods for Generating and Scanning Codes.” By this reference, the entire disclosure, including the specification and drawings is hereby incorporated into the present disclosure as if set forth in their entirety.

### BACKGROUND OF THE INVENTION

### 1. Field of the Invention

The present invention relates to systems and methods for generating and scanning codes. More particularly, the invention relates to systems that enable computerized devices to scan screens of devices, barcodes, QR codes, and other elements.

### 2. Description of Related Art

Normally scanners and detectors are limited in their capabilities by the sizes and details of the machine-readable, detectable, identifiable, and scannable elements. Scanners and detectors require a specific size of a scannable element and specific details to be able to scan them specially if they are presented on a screen.

For QR codes to be scannable from a screen or a picture, it must take a lot of area (space) on the screen or in the picture to be scannable which may block parts of the media. Small size QR codes and barcodes are not scannable by traditional screen scanners. QR codes and/or Barcodes scanners can only scan one code at a time. Scanners cannot read small scannable elements from pictures within the same device. In case of scanning small scannable elements from a picture, the scanners are not able to read them. There are currently no methods available for scanning the screens directly. Screen scanner systems or internal scanning systems can't scan or detect small elements. Screen scanner systems or internal scanning systems can't scan or detect multiple elements or multiple QR codes from a single object. Scanning using a camera app can only detect one QR code or one Barcode at a time.

Items usually uploaded to the Internet are not associated with scannable identifiable marks for each of them, but even if they are associated with such marks like codes or scannable shapes, they require a big size on the items to be scanned from the screen. Users will also require a long complex process of taking a screenshot, focusing on the scannable elements, cropping and maybe more manual processing of the item in order to be able to scan an item from a computerized device screen. Thus, there is a need in the field for an improved system and method able to eliminate the scanning limitations.

### SUMMARY OF THE INVENTION

The system described in the present disclosure is intended to enable computerized devices to scan the screens of their own device or to scan the screens of other devices with or without using a camera by a trigger using one or multiple methods. An example of how the system scans other screen devices is explained in the FIGUREs (e.g. FIG. 21).

The system provides also new methods for scanning from a screen of a computerized device or a digital camera. The present disclosure is also intended to provide a new method that reduces the required details and size to scan a QR code or any other scannable element directly from the screen or by input into a scanning system. The present disclosure is intended also to provide a new method to scan single or multiple QR codes, barcodes, or any other scannable and identifiable elements singular or combined by one or multiple triggers.

The system provides targeted location scanning from a camera or a screen. The system can perform processes before or after presenting the results. An example of performing a process before the results is showing a warning about the scanned element source. The system can present suggestions for further processes to be triggered by the user such as forwarding one or multiple results or after processes results. The system can perform processes based on the full scanning results then view those processes results. The system is able to trigger full scanning before, during or after uploading a media or non-media file. The system can also trigger the full scanning on an open digital camera screen or stream.

The full scanning process and/or the scanning enhancement process can be done automatically, or triggered by a user, or triggered by a detector or an operator of the system. The trigger for full screen scanning can be before or during or after the location/s for enhanced scanning is determined. The system is able to trigger full scanning automatically before, during or after selecting the location to be scanned on the screen. The system can be set so that the user can target the location for full scanning on the screen by multiple methods, an example for targeting a location on the screen after triggering full scanning is explained by shaking a smartphone (trigger) then selecting the location for full scanning on the screen (location selection).

When full scanning is triggered on a certain location on the screen, the system is able to a. take a screen shot then b. crop that certain selected location and scan it, or alternatively the system is able to a. focus on (zoom in) that certain selected location on the screen then b. take a screenshot of that certain selected location. The methods of scanning enhancement can be applied to images and photos scanners and can be applied to other scanning systems and methods. The location/locations of the scanning enhancement can be pre-set in the system, or directly located by a user of the system before, during or after triggering scanning.

These and other features and advantages will be apparent from reading of the following detailed description and review of the associated drawings. It is to be understood that both the forgoing general description and the following detailed description are explanatory and do not restrict aspects as claimed.

### BRIEF DESCRIPTION OF THE DRAWINGS

FIG. 1 illustrates a diagram for an example scanning enhancement process logic flow.

FIG. 2 illustrates a diagram for an example logic flow full scanning process triggered automatically.

FIG. 3 illustrates a logic flow diagram explaining example process of pre-set location scanning in combination with automatic location setting scanning processes to get a full detailed scanning.

FIG. 4 illustrates a logic flow diagram for an example process of scanning using a floating button, in combination with a full detailed scanning process.

FIG. 5 illustrates an example logic flow diagram for scanning multiple scan-able elements.

FIG. 6 illustrates an example of multiple identifiable and scannable elements on a screen of a computerized device.

FIG. 7 illustrates an example of the full scanning interactive results that happen automatically after full scanning is triggered on the screen of the computerized device.

FIG. 8 illustrates an example of a screen of a computerized device showing a video playing on a PC screen with multiple identifiable QR codes.

FIG. 9 illustrates an explanatory example of the system functionality, where the system is using pre-set locations like square to focus on and/or crop after the scanning is triggered where pre-set locations method is implemented for enhancement.

FIG. 10 illustrates an explanatory example of how the scanner within the system is receiving each divided and cropped part of the complete picture and scans each one individually after full scanning is triggered.

FIG. 11 illustrates an example result for scanning all the elements in the screen of the device using one trigger such as full scanning command.

FIG. 12 illustrates a user of the system on a computerized portable device using the device to scan multiple elements while the camera is displaying on the screen.

FIG. 13 illustrates an example result of scanning using the device shown in FIG. 12.

FIG. 14 illustrates a computerized device showing a floating button and two QR codes on its screen which are not scannable at this size by any other screen or image scanner.

FIG. 15 illustrates how a user can scan specific element or location on the screen by dragging the floating button to the place of the desired to be scanned element or location and then release the floating button.

FIG. 16 illustrates an automatic result in the system after focusing and then taking a screenshot, or cropping the screenshot taken on the scanning command shown in FIG. 15.

FIG. 17 illustrates the scanning results of the cropped/focused on screenshot in FIG. 16.

FIG. 18 illustrates other uses of the system where single or multiple scanners, cameras or detectors are connected to the system and mounted on a moving vehicle.

FIG. 19 illustrates when the system is triggered to scan the signs on the road shown in FIG. 18 where the system automatically led to a process of decreasing the speed of the vehicle.

FIG. 20 illustrates a screen displaying scanning results of the system.

FIG. 21 illustrates an example of how full scanning on a screen is triggered by another remote device.

### DETAILED DESCRIPTION OF THE INVENTION

The following descriptions relate principally to preferred embodiments while a few alternative embodiments may also be referenced on occasion, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise. In light of the present disclosure, those of ordinary skill in the art should also appreciate that many changes can be made relative to the disclosed embodiments while still obtaining a comparable function or result without departing from the spirit and scope of the disclosure.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,”“comprising” or “including.” Likewise, “another” object may mean at least a second object or more. Thus, in the context of this specification, the term “comprising” is used in an inclusive sense and thus should be understood as meaning “including, but not limited to.” As used herein, the use of “may” or “may be” indicates that a modified term is appropriate, capable, or suitable for an indicated capacity, function, or usage, while considering that in some circumstances the modified term may sometimes not be appropriate, capable, or suitable.

References to particular proprietary names are made as examples but do not limit the systems and methods disclosed herein. A “computerized device” is defined as including mobile phones, smartphones, tablets, laptops, and any other computerized device able to support the features described herein. “Media files” are defined as including image files, picture files, video files, live stream video, audio files, text documents and the like. “Items” are defined as including articles of manufacture, other products, media files, and the like. The terms “embed” and “affix” are used interchangeably in the disclosure to describe the same process. The terms “image” and “picture” are used interchangeably in the disclosure to describe the same type of media file. Any “examples” described herein are non-limiting.

The scannable elements may include but are not restricted to hashtags, symbols, faces, facial expressions, shapes, forms, QR codes, Barcodes, colors, images, letters, faces, characters, detectors, numbers, mathematical equations, colors, signatures, or any other identifiable and scan-able elements or a combination of them. A detector is a defined herein: any shape, color, image or picture or a combination of two or more of them, that will identify the presence, location, type, position or size of a scan-able element or lead to a process or eliminate a process as a result for detecting them. Items may include without restrictions writings, videos, pictures, posts, media, live stream media, documents, files, products or a combination of more than one item. Computerized devices may include without restrictions: smartphones, screens, computer, processors, servers, memory storage mediums, scanners, smart screens, detectors, cameras, smartphones or a combination of more than one device.

A full scanning process is defined herein: a process which happens within a computerized system connected to a device or multiple devices to obtain, read, scan and detect all the recognisable, detectable, readable, identifiable and scan-able eliminates even if they have small sizes from any or multiple devices attached to the system. A full scanning process performed by the system may start after triggering a full scanning command (trigger) by: Scanning using the screen of a camera by taking a screenshot from the screen associated with the camera then performing more processes including other scanning processes; or it may start by automatically taking a screenshot from a screen then scanning that screenshot, then performing more processes including other scanning processes; or by capturing screenshot then cropping it and scanning one or multiple cropped parts, then performing more processes including other scanning processes; or by focusing on/cropping a screenshot and scanning that cropped part(s) of the picture, then performing more processes including other scanning processes; or by settling a location to focus the scanning in it, then performing more processes including other scanning processes.

A direct full scanning from the screen in this system is possible using any preset trigger such as a button, or movement of the portable device in a pre-set pattern or shaking, or by input attached devices, or by giving a voice command, or using a floating button, or any other tool or trigger that is preset in the system to perform an automatic full scanning on the screen.

Full scanning process can be triggered automatically or triggered by single or multiple commands, internally or externally. An example for an external trigger is a voice command or a button on a remote control that triggers the screen of a computerized device to perform full scanning process. An example of internal trigger is the detectable movement of a portable device or an automatic internal trigger performed each period of time or on certain point of time.

The system offers direct screen full scanning triggers, which will lead to capturing screenshot from the screen of the same device or other devices and performing full scanning on it. The system offers identifiable, readable and/or scan-able elements entry and/or processing for each item entering the system (such as media) by the user, making a method for referencing each item entering the system and offering the easiest and most functional ways to scan them by a single command or multiple commands per request from the user or automatically (like to identify each of the entering items), and performing processes based on all of that.

Full scanning may be triggered by any kind of possible triggering methods automatically or manually. Examples of an automatic trigger for the full scanning process are such like a detector on a screen of a computerized device like camera can trigger full scanning, or by turning the camera on, or automatically set full scanning of the screen for each period of time, the system can also be triggered to perform full scanning directly on data entry.

Examples of manual triggering are: voice command, a pre-set action done by a user, or by a combination of multiple triggers, which are set in the system. An example of those actions is using a floating button by clicking on it on the screen that is required to be scanned, or dragging it to set a location for detailed scanning, another example is triggering the scanner by moving the portable device in a pre set movement such as shaking the device, rotating it, or tilting it. The scannable element using this system may include without restrictions one or more types of any identifiable elements such as QR codes, Barcodes, faces, symbols, hashtags, signatures, shapes, numbers, characters, letters, math equations, or a combination of those identifiable objects.

The system can scan multiple scan-able objects from any source/s using one or multiple detecting and scanning device/s such as camera, scanner or a combination of them and perform any process or combination of processes based on the scanning and detection results with or without user interactions. An example of automatic interactions between the user and the system is: giving notifications after full scanning or detecting. An example of an automatically driven processes between the system and users: sorting the scanning and detecting results based on user's requests.

The system can count the numbers of each element scanned and perform processes based on those counts, such as sorting. The system can scan or detect from a continuous, streaming, movable or static objects. This scanning system will enhance the capability of any scanner, camera or detector. The locations that require scanning enhancement are determined by one of those methods: automatically; selecting the desired location for enhancement using Floating button or any other selection method obtained by a device attached to the system like touch screen, touch pad, or PC mouse (this may be performed in the system in two ways: trigger->screenshot->cropping->scanning; or trigger->focusing->screenshot->scanning; pre-set locations.

Full and detailed scanning on an object (scan-able/detectable medium/screen) with enhancement of the details of the smaller and/or multiple elements, can be done using a computerized device which is maybe attached but not limited to one or more devices like camera, scanner, screen, detector or a combination of them, through one or combination of the following methods after full scanning is triggered:
1) Automatically the system will capture or take a screenshot of the object and then the system will automatically perform initial scan that scans the complete screenshot or the captured object for readable scan able elements or detector/s of scan-able elements. All the completely identified elements detected will be saved for later presenting with the rest of the full scanning results. If the identified elements of the scanned object or objects includes/are detectors for identifiable elements (like specified marks, facial landmarks, QR code and/or Barcode detectors, symbols, shapes, letters, numbers, characters, or other elements) with more detailed and/or smaller elements then the system will locate the place of each of those detected detectors to separate each one of them individually by cropping and to focus on each one of them by cropping each one out of its unidentifiable surroundings each one individually, that will lead to a bigger and more detailed identifiable element that the system is able to scan and read automatically. After that the system performs secondary scanning which will scan each one of those separated cropped and focused on elements. The scanner will be able to detect smaller details of each element which were not scan-able or readable in the first initial scan. If new detectors were found in the secondary scan, the process of separation, focusing on/cropping and then scanning with more details will be done again to get the new elements. The system can then perform any process based on the results of full scanning.
2) One or more scanning locations can be pre-set in the system by an operator or user of the system. When full scanning is triggered, the system will capture or take a screenshot of the object, the system will perform an initial scan to scan the complete captured object or screenshot and save the results if found, then the system will crop or focus on each of the pre-set locations separately and then scan each one individually and save each result. The system will perform any process or combination of processes based on the full scanning results such as organising, sorting, and scanning results and displaying them for the user. This will increase the capability of the scanner to scan smaller elements on objects and will result in scanning multiple elements including multiple codes (QR codes and/or Barcodes) through only one scanning command from one or multiple sources.
3) The system offers multiple methods to scan and detect small elements and enhance the scanner capability. Among those methods there is a method for precise selection of location for full scanning on an object presenting on a screen that is attached to the computerized device of the system using any available input method for determination of the location on an object such as touch screens, touch pads, pc mouse or any other location determination input devices attached to the screen. An example of special method is using a floating button on the screen. Among other functionalities of the floating button, when the user wants to scan an object that has scan-able element or elements, the user will drag that floating button over the desired scan-able element on the screen (or in an alternative example process the system can be set to scan a precise location by the floating button by one click on the floating button then clicking on the desired to be scanned element) which will result in:

A) Saving the new location of the floating button (or the second click) on the screen after being dragged and released, which is the location that will be remaining after cropping and will undergo a second scanning. B) Disappearance of the floating button until a screenshot is automatically taken and saved.

Next, the system scan the saved screenshot as initial scan, then the screenshot is focused on and/or cropped leaving the area surrounding the floating button intact (automatically), resulting in more detailed readable cropped part of the screenshot that the scanner will be able to scan and identify. Then, the scanner will scan and detect all the elements from that remnant of the cropped screenshot in the same location of the dragged floating button. If any detectors were found from both of the initial scan and the second scan, the system will perform further cropping, focusing, saving and scanning on each detector location as needed using one or more of the previously explained methods. After the complete object (here the screen as well the screenshot of that screen) is fully scanned and the elements are identified, the system can perform any process or combination of processes based on the scanning results, like presenting them to users. The system can repeat any of the identification, detecting, separation dividing, cropping, scanning or any other process involved in the system as much as needed until all the identifiable elements are identified.

The system will be able to identify, scan, read, recognise and detect multiple elements like (faces, codes, writings, symbols, locations, letters, math equations, barcodes, QR code, symbols, numbers, characters, letters or any element that the system can recognise as scan-able element) in combination or separately.

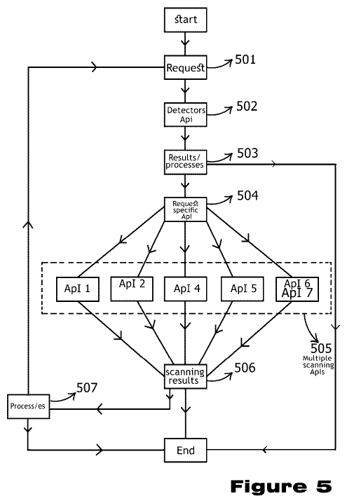

An example logic flow diagram for scanning multiple scan-able elements is explained in FIG. 5. In case of multiple results, the system will perform comparison, organisation, differentiation, sorting, or any other required process or combination of processes between the detected, identified and scanned results. The system will enhance any scanning capability of any scanner if one of the enhancement methods is applied on a screen scanner or camera scanner.

The system will offer any scanner the special capability of scanning more than one QR code or more than one Barcode among other scan-able objects like faces writings, numbers, symbols, letters or any other identifiable element by a single command triggered by the user or automatically. The system will be able to deliver more options and/or processes after receiving all the scanning results. The system offers full scanning in which the user will not be required to do any process between the scanning command and the results (whether it is a process or a combination of processes or only direct scanning results) to enhance the quality of the desired to scan object (enhancement like focusing or cropping the object) or to obtain detailed scan-able object. The system will do all of that automatically. The system will scan and check items uploaded by users to the system for any previous intellectual property marks, numbers, names, symbols, shapes, detectors, codes, letters, faces or any kind of indicators using one or a combination of its methods of scanning to reduce or eliminate any intellectual property misuse or unauthorized sharing.

The system will be able to give notifications to the users based on any scanning or detecting results (Example: notifying an intellectual property rights holder that the mark for that property is detected by the system whether it is a signature, logo, shape, code or any identifiable element that leads to the owner or owner's product/s).

The system can scan multiple elements with only one or more full scanning trigger/s and define them, and then perform any process or combination of processes based on the scanning results. An example of that process is scanning and/or detecting a phone number among other elements like texts and multiple QR codes from a screen and suggesting for the user a quick shortcut to call that number among other suggestions like reaching one of the QR codes sources. The system is able also to generate scanning identifiable marks like codes, names or any other type of identification for each item uploaded to the system for intellectual properties protection, tracing or for any other required process.

The system can receive new identifiable or scan-able elements, identify them and save them within its memory to be used as an reference for later scanning or identifying. The system can receive any type, shape or form of identifiable, detectable, scan able signatures, face landmarks, new or old symbols, shapes, colors or any other identifiable element each alone or multiple elements in combination, and save those elements in the system for future references, scanning or any other process or combination of processes.

The system is able to generate or process One identifiable scan-able reference element (such as a QR code) for one or multiple items. The system can give each uploaded item an identifiable and scan-able element and process it only by one command. The system can generate multiple scan-able elements for multiple items and process them on those multiple items. The system can also generate one scan-able identifiable element to be processed on multiple items. The system can by one command or trigger activate all the system connected devices like multiple cameras, microphones, detectors, scanners sensors and others, to scan for identifiable elements such as shapes like logos, QR code or barcodes, symbols, letters or any other type of scan-able, detectable or identifiable marks, and later on perform any process based on the results of scanning one or multiple elements of those, such as sorting, displaying, identifying, streaming or even further sharing of one or more of those findings. The system can be triggered automatically to run any full scanning processes before, during or after the data enters the system.

The system can use SINGLE COMMAND SYSTEMS AND METHODS FOR GENERATING CODES AND SCANNING ITEMS to process any identifiable mark (like intellectual property marks) on any media or medium to be used as an identifiable reference for that media, or to do any process or combination of processes. The system can generate scan-able and identifiable element such as a QR code and use it as an identification mark on media or items. The system can generate multiple identifiable elements like QR codes for multiple further processes using one command. An example is when multiple media files are uploaded to the system, the system will generate automatically for each one of those media files new QR code or any other identification scan-able element. The scanner APIs may exist within the same scanning device, or within another device or even in multiple devices.

The system can use a SINGLE COMMAND SYSTEMS AND METHODS FOR GENERATING CODES AND SCANNING ITEMS to trigger the scanning processes. The system can use other trigger options to start full scanning such as certain movements of a portable computerized device. The system can perform security checks to detect any traces of previous intellectual property marks. The system can present the results as overlay of full scanning on a scan-able object with minimum distortion. The system is able to create automatically or manually multiple tasks scan-able elements, and scan those elements combined or separately. The system is able to save the scanning results for each user as scanning history. The system also can save each scanned element by the user as scanning history. The system is able to perform automatic processes or user triggered processes based on the scanning results. When a detector or a small element is identified using the system, the detector's location or coordinates are saved automatically so that the system can perform enhanced full scanning on those locations.

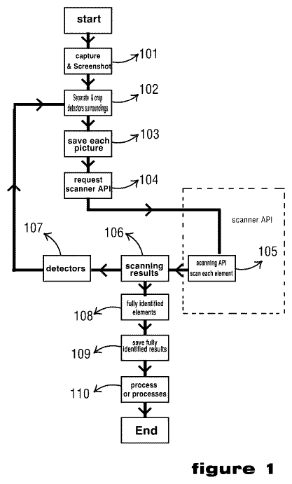

FIG. 1 illustrates a diagram for an example scanning enhancement process logic flow. The process which the system performs fully automatically starts with or without a trigger on a previously scanned or not scanned screen shot from a screen (object) 101, that object that the system previously have scanned or not is requested to be fully scanned (automatically or user triggered) by the system because there are unidentified small elements or detectors for other smaller elements that were not scannable (example: in case of a detector from a previous scan). Each detector will be separated in a way that each detector will be in a separate picture and its unnecessary surroundings will be cropped to keep each of the scannable or identifiable elements intact, each in a single picture 102. Then each remaining element picture will be saved separately with obvious details after cropping 103. The system will then request the scanning API or APIs to scan each saved element (bigger size and more detailed after cropping the unnecessary surroundings) 104. The scanning API will scan each element 105, and the system will then divide the scanning results 106 and sort them in two categories which are the detectors of smaller identifiable elements 107, and the fully identified elements 108. The detectors locations will be going through the same enhancement process starting with dividing and surroundings cropping leaving the detectors more detailed and bigger 102 until all the elements are fully identified. All the results of fully identified elements will be then saved by the system 109 for further processes 110 such as sorting them and presenting them for a user of the system.

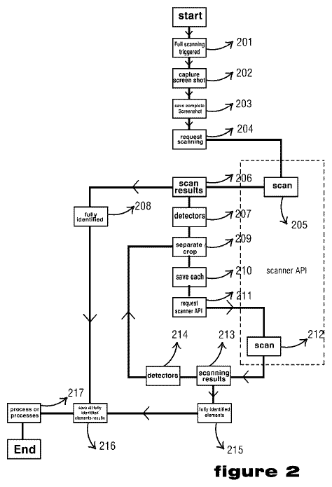

Turning to FIG. 2, there is a diagram for an example logic flow full scanning process triggered automatically (example: continuously over each period of time like during streaming or during camera capture) or user triggered full detailed scanning process. After each scanning trigger 201, the system will capture the present screenshot 202, then this captured screenshot will be saved within the system 203. Next the system will request from the scanning API to scan the saved captured screenshot 204.

After scanning is done 205, and the system will then divide the scanning results 206 and sort them in two categories which are the detectors of smaller identifiable elements 207, and the fully identified elements 208. Each detector will be separated in a way that each detector will be in a separate picture and its unnecessary surroundings will be cropped to keep each of the scannable or identifiable elements intact, each in a single picture 209. Then each remaining element of the cropped screenshot will be saved separately with obvious details after cropping 210. The system will then request the scanning API to scan each saved element (bigger size and more detailed after removing the unnecessary surroundings) 211. The scanning API will scan each element in each cropped picture of each detector and element 212, and the system will then divide the scanning results 213 and sort them in two categories which are the detectors of smaller identifiable elements 214, and the fully identified elements 215. The detectors locations will be going through the same enhancement process starting with separation and surrounding cropping for each detector 209 until all the elements are fully identified 215. All the results of fully identified elements 208 and 215 will be then saved by the system 216 to perform further process or processes 217 such as presenting results of the full scanning including multiple QR codes scanning results and identification of one face of a person who his face was recognised through the scanning process.

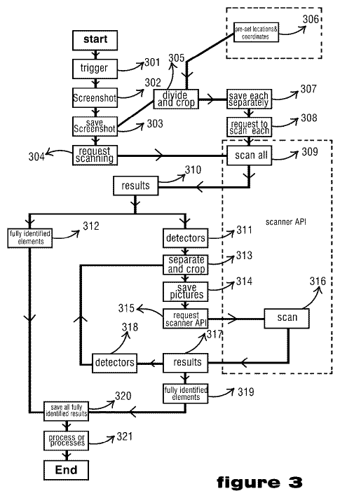

Turning to FIG. 3, there is a logic flow diagram explaining example process of pre-set location scanning in combination with automatic location setting scanning processes to get a full detailed scanning. The process starts with an automated trigger or a user driven trigger for scanning 301, the system will take a screenshot 302, the system will save that screenshot 303, the system will request the scanning API to scan the complete screenshot 304, the system will also divide and crop the screenshot in the pre-set location or locations 305 which were set previously in the system by the system operator or a system user/s 306, each remaining separated and cropped picture from the first screenshot will be saved 307, and the system will request the scanning API to scan separately each saved picture 308, the scanner API will scan all of the saved eliminates (before cropping 303 and the saved after cropping 307) each one separately 309, the system will then divide the scanning results 310, and sort them in two categories which are the detectors of smaller identifiable elements 311, and the fully identified elements 312. Each detector will be separated in a way that each detector will be in a separate picture and its unnecessary surroundings will be cropped to keep each of the scannable or identifiable elements intact, each in a single picture 313. Then each remaining picture of each detector will be saved separately with obvious details after removing and cropping the surroundings 314. The system will then request the scanning API to scan each saved element (bigger size and more detailed after removing the unnecessary surroundings) 315. The scanning API will scan each element 316, and the system will then divide the scanning results 317, and sort them in two categories which are the detectors of smaller identifiable elements 318, and the fully identified elements 319. The detectors locations will be going through the same enhancement process starting with dividing and surrounding cropping 313 until all the elements are fully identified 319. All the results of fully identified elements 319 and 312 will be then saved by the system 320 for further processes and uses 321 such as scanned results comparison process.

FIG. 3, there is a logic flow diagram explaining example process of pre-set location scanning in combination with automatic location setting scanning processes to get a full detailed scanning. The process starts with an automated trigger or a user driven trigger for scanning 301, the system will take a screenshot 302, the system will save that screenshot 303, the system will request the scanning API to scan the complete screenshot 304, the system will also divide and crop the screenshot in the pre-set location or locations 305 which were set previously in the system by the system operator or a system user/s 306, each remaining separated and cropped picture from the first screenshot will be saved 307, and the system will request the scanning API to scan separately each saved picture 308, the scanner API will scan all of the saved eliminates (before cropping 303 and the saved after cropping 307) each one separately 309, the system will then divide the scanning results 310, and sort them in two categories which are the detectors of smaller identifiable elements 311, and the fully identified elements 312. Each detector will be separated in a way that each detector will be in a separate picture and its unnecessary surroundings will be cropped to keep each of the scannable or identifiable elements intact, each in a single picture 313. Then each remaining picture of each detector will be saved separately with obvious details after removing and cropping the surroundings 314. The system will then request the scanning API to scan each saved element (bigger size and more detailed after removing the unnecessary surroundings) 315. The scanning API will scan each element 316, and the system will then divide the scanning results 317, and sort them in two categories which are the detectors of smaller identifiable elements 318, and the fully identified elements 319. The detectors locations will be going through the same enhancement process starting with dividing and surrounding cropping 313 until all the elements are fully identified 319. All the results of fully identified elements 319 and 312 will be then saved by the system 320 for further processes and uses 321 such as scanned results comparison process.

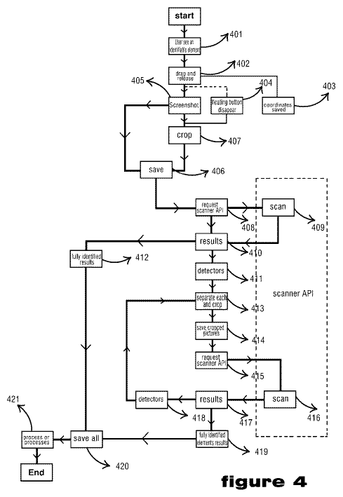

Turning to FIG. 4, it shows a logic flow diagram for an example process of scanning using floating button, in combination with full detailed scanning process. After a user see an identifiable elements on the screen 401, the user drags the floating button on the screen (using: mouse, touch pad, touch screen . . . ) and release the floating button over the desired to be identified or scanned element/s 402, the floating button coordinates on the screen will be saved after release 403, and the floating button will disappear 404 until an immediate screenshot is taken 405, then the floating button is back. The system will save the complete screenshot 406. The saved coordinates of the floating button 403 will be used by the system to remove and crop approximate surroundings of the location of the floating button 407, then the system will save the remaining elements of that cropped screenshot 406. The system will then request scanning API access 408 to all of the saved elements 406, and those will be scanned 409. The scanning API will scan each saved element 409, and the system will then divide the scanning results 410 and sort them in two categories which are the detectors of smaller identifiable elements 411, and the fully identified elements results 412. Each detector will be separated in a way that each detector will be in a separate picture and its unnecessary surroundings will be cropped to keep each of the scannable or identifiable elements intact, each in a single picture 413. Then each remaining element will be saved separately with obvious details after cropping 414. The system will then request the scanning API to scan each saved element (bigger size and more detailed after removing the unnecessary surroundings) 415. The scanning API will scan each element 416, and the system will then divide the scanning results 417 and sort them in two categories which are the detectors of smaller identifiable elements 418, and the fully identified elements 419. The detectors locations will be going through the same enhancement process starting with dividing and surrounding cropping 413 until all the elements are fully identified 419. All the results of fully identified elements 419 categories which are the detectors of smaller identifiable elements 411, and the fully identified elements results 412. Each detector will be separated in a way that each detector will be in a separate picture and its unnecessary surroundings will be cropped to keep each of the scannable or identifiable elements intact, each in a single picture 413. Then each remaining element will be saved separately with obvious details after cropping 414. The system will then request the scanning API to scan each saved element (bigger size and more detailed after removing the unnecessary surroundings) 415. The scanning API will scan each element 416, and the system will then divide the scanning results 417 and sort them in two categories which are the detectors of smaller identifiable elements 418, and the fully identified elements 419. The detectors locations will be going through the same enhancement process starting with dividing and surrounding cropping 413 until all the elements are fully identified 419. All the results of fully identified elements 419 and 412 will be then saved by the system 420 for further processes and uses 421 such as calling the identified owner of the scannable elements or connecting with the owner of an identified face.

FIG. 5 is a diagram of an example process for a method that enables scanning multiple types of scannable elements and reduces the number of identification APIs required to scan, therefore it reduces the load and increases the speed and accuracy. The process starts after a request to scan is given to the system 501, the scan process may start by scanning the items using Detectors API or APIs 502, based on the detectors APIs results the system is able to perform further processes such as focusing and cropping 503, then based on the processes and results the system will request the correct required scanner API or APIs to fully identify each element 504. The scanning APIs will identify each scannable element individually 505 and produce results based on those scans 506. Those result may undergo further processes 507 such as further scanning. The system can request and/or combine multiple scanning APIs. FIG. 5 also explains a quick method to stop scanning or eliminate further processes or results after 503 as a result for specific detectors scanning results. According to the method in FIG. 5, one scanning API may include multiple scanning APIs.

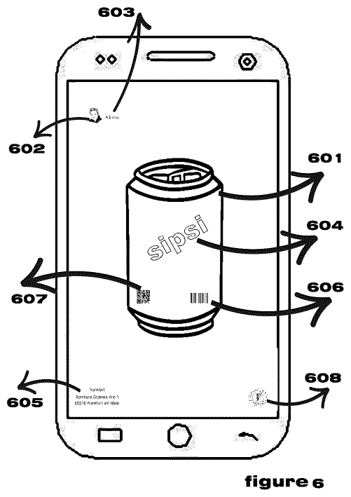

FIG. 6 is an example of a multiple identifiable and scannable elements on a screen of a computerized device (smartphone). The screen contains elements such as a product of manufacture 601, a face 602, a name 603, a product name 604, an address 605, a barcode 606, a QR code 607, and another QR code 608.

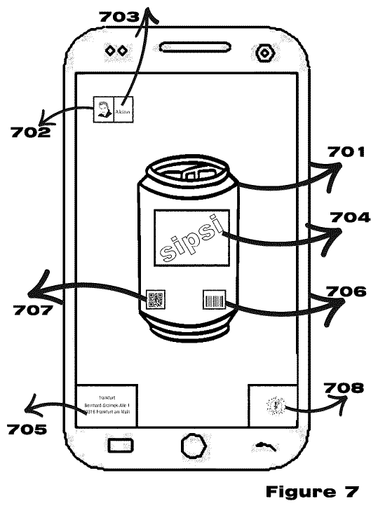

FIG. 7: Is an example of the full scanning interactive results that will happen automatically after full scanning is triggered on the screen of the computerized device (smartphone) in FIG. 6, where each recognised element of the picture is separately identified and previewed for further interactions. FIG. 7 may also represent a pre-enhanced scanning process step after triggering scanning. For example a user triggering scanning in the device in FIG. 6 will lead to this result, then the user by clicking on the desired element to be scanned on the touchscreen will lead to perform the enhanced scanning on the location of the click on the touchscreen. To explain in other words, the system can scan the screen of the computerized device in FIG. 6 fully automatically, and the user can directly interact with the results or perform a process, or alternatively the system can perform a scan on that screen to detect all the detectors then the user may select which of the elements is wanted to be scanned separately and with enhanced scanning for example by clicking on the touchscreen over the desired scannable element.

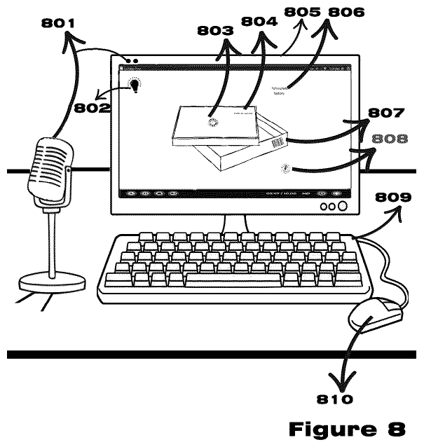

FIG. 8: Is an example of a screen of a computerized device showing a video playing on a PC screen with multiple identifiable QR codes 803 & 808, a barcode 807 a manufacturer name 806, and a Hashtag 804. Using this system the device is able to perform screen scanning using a microphone 801 by a voice command, using the mouse of the device 810 and clicking on a button on the screen 805, using a keyboard button or a touch pad attached to the keyboard 809, or by clicking on a floating button 802 using the touchscreen 805. At this size and details any screen scanner is not able to identify or scan the QR code, the Barcode the hashtag or the faces within the QR codes. But using this system of the present disclosure and the methods of enhancement implemented in it, full scanning is capable of scanning all the elements in the screen as shown in an example process in the next figures.

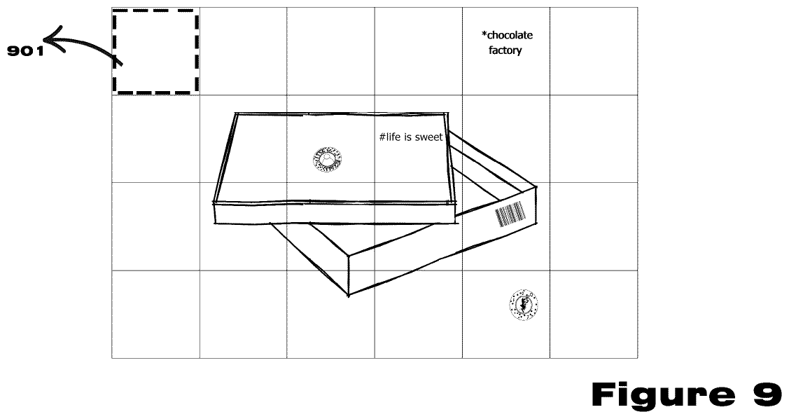

FIG. 9: is an explanatory example of the system functionality, where the system is using the pre-set locations like 901 square to focus on and/or crop after the scanning is triggered where pre-set locations method is implemented for enhancement. Each block or square in the taken screen shot or picture is a target for scanning after cropping and/or focusing. For example the system will crop squares like 901 or multiple pre-set locations and save each separately, then the system will scan each square separately. The system may take one or multiple spaces like 901 from the original screen shot or picture and perform cropping and scanning on them each individually or separately as much as needed.

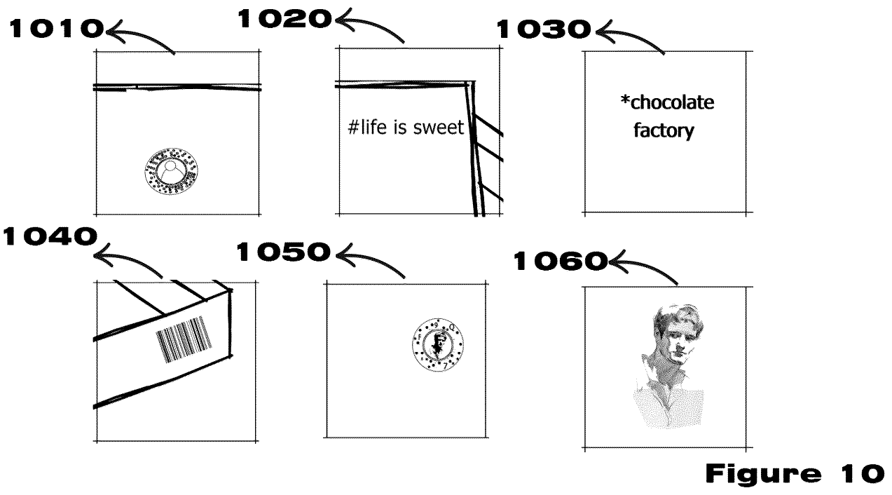

FIG. 10: is an explanatory example of how the scanner within the system is receiving each divided and cropped part of the complete picture and scan each one individually after full scanning is triggered on the screen of FIG. 8. The scanner API will receive request to scan 1010 which has the QR code 803 in it, then the scanner API will receive request to scan 1020 which has the hashtag 804 in it, then the scanner API will receive request to scan 1030 which has the manufacturer name 806 in it, then the scanner API will receive request to scan 1040 which has the barcode 807 in it, then The scanner API will receive request to scan 1050 which has another QR code 808 in it, then the scanner API will receive request to scan 1010 which has the QR code picture of 808 in it.

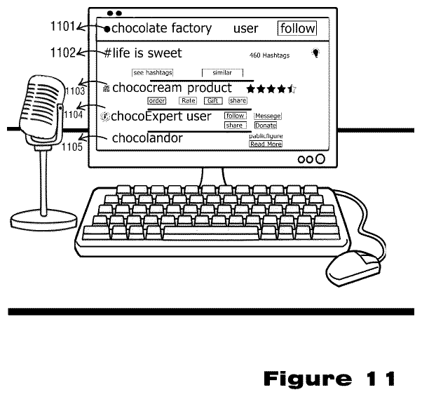

FIG. 11 is an example result for scanning all the elements in the screen of the device in FIG. 8 using one trigger such as full scanning command using the system and pre set scanning enhancement locations in the system. The results appearing in the screen of FIG. 11 with or without a process, directly after a full scanning command is triggered, such as pressing the floating button 802 on the screen of FIG. 8. The results showing are presented with or without previous processes done based on the scanning results. 1101 is the result of scanning 1030. In 1102 the result of scanning 1020 and performing a process (counting the number of posts using that hashtag) based on that scanning results then previewing both of the scanning results and the process results that were based on the scanning results and then suggesting similar items with the same hashtag that was identified by scanning the screen. Going to 1103 is the result of scanning the QR code 1010 and the barcode 1040 and removing one of the results because they are similar and presenting ratings from other users. Going to 1104, it is the result of scanning 1050 and the system performing processes based on the scanning results such as suggesting to share or follow. Going to 1105 there is the result inside the QR code 808 by performing full scanning on 1060.

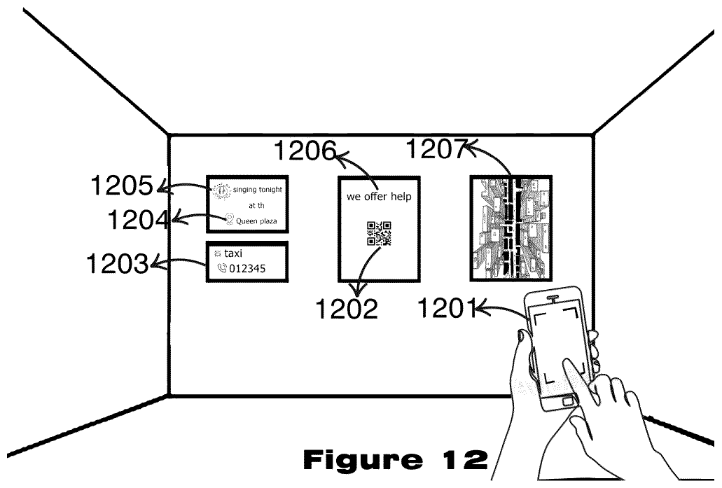

Turning to FIG. 12, a user of the system on a computerized portable device (smartphone) 1201 is using the device to scan multiple elements while the camera is displaying on the screen. For example the user will use a voice command to trigger full scanning while the camera is open without the need to capture a picture using the camera application The system will take a screen shot and then performs full scanning based on that screen shot.

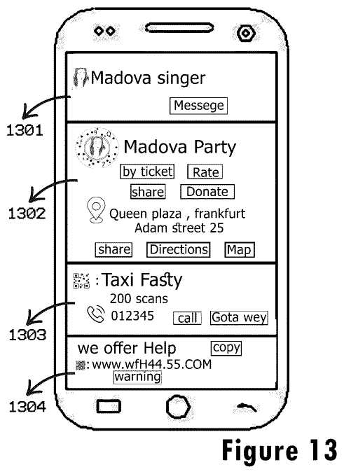

FIG. 13 is an example result of scanning using the device 1201 in FIG. 12. The result of the identification of face inside the profile QR code 1205 is presented along with messaging suggestion in 1301. The results of scanning both of the event QR code 1205 and the printed Location symbol and address 1204 then correcting the address according to the information given are showing in 1302. The system detected in 1203 a phone number symbol as a detector and therefore it scanned using a numbers scanning API, then throughout the phone numbers registered in the system it presented the number and its owner plus suggestions for future processes 1303. The system also detected the writings in 1206 and the QR code 1202 then produced a warning message along with the scanning results based on previous users interactions with those results 1304.

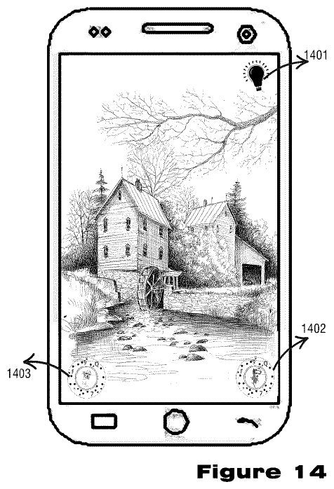

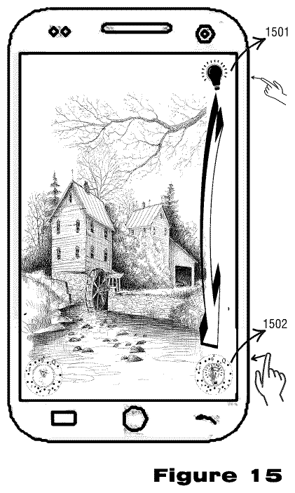

Turning to FIG. 14, a computerized device is showing a floating button 1401 and two QR codes on it's screen 1402 and 1403 which are not scannable at this size by any other screen or image scanner. The user can click on the floating button offered by the system and get a full screen full scanning results which will present the results of scanning the two QR codes 1402 and 1403. Alternatively the user instead of scanning the full screen, the user can scan specific element or location on the screen by dragging the floating 1501 button (as explained in FIG. 15) to the place of the desired to be scanned element or location 1502 and then releasing the floating button.

The system will either focus on the new location of the floating button 1502 then take a screenshot and perform full scanning on it, or the system will take a screenshot then crop it and then perform full scanning on that cropped part. The system will either focus on the new location of the floating button 1502 then take a screenshot and perform full scanning on it, or the system will take a screenshot then crop it and then perform full scanning on that cropped part.

The system will either focus on the new location of the floating button 1502 then take a screenshot and perform full scanning on it, or the system will take a screenshot then crop it and then perform full scanning on that cropped part. The system will either focus on the new location of the floating button 1502 then take a screenshot and perform full scanning on it, or the system will take a screenshot then crop it and then perform full scanning on that cropped part.

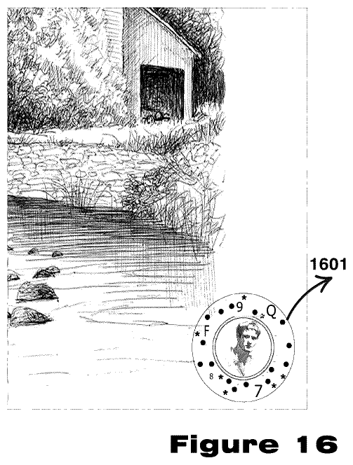

Turning to FIG. 16, this is the automatic result in the system after focusing and then taking a screenshot, or cropping the screenshot taken on the scanning command given in FIG. 15. The system will request the scanner APIs to scan this cropped/focused on screenshot. The same code 1402/1502 will be scannable after cropping/focusing on its location because it is more detailed as shown in 1601. Using this specific location and element scanning will result in scanning only the one desired to be scanned code (1402, 1502, 1601).

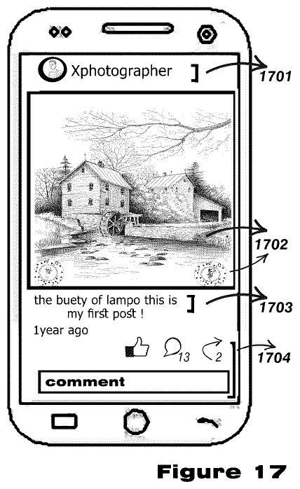

FIG. 17 is showing the scanning results of the cropped/focused on screenshot in FIG. 16. The results includes the owner's name 1701 of the original picture that was displaying on the computerized device in FIG. 14, the results includes also the picture it self 1702, also the details and the description given about the picture 1703, the results includes also suggestions to forward, share, like or even comment on the original picture.

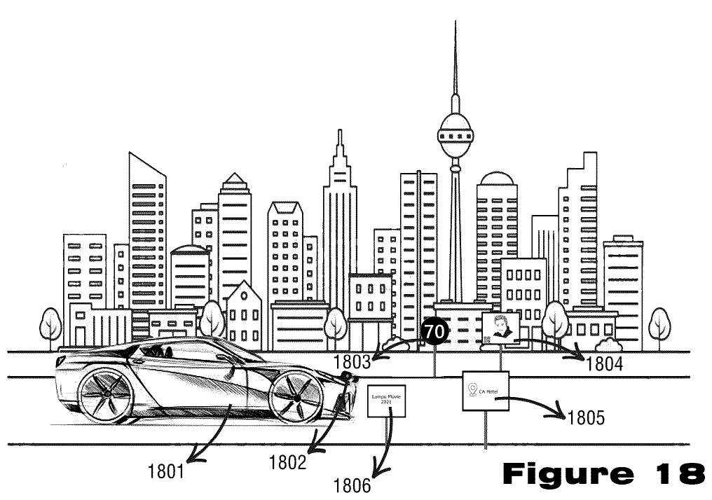

FIG. 18 is showing other uses of the system where a single or multiple scanners, cameras or detectors 1802 are connected to the system and mounted on a moving vehicle 1801. FIG. 18 is also showing multiple street signs that includes multiple identifiable elements on them such a speed sign 1803, a face and QR code sign 1804, a location sign 1805, and an advertisement sign 1806. The system as explained earlier offers multiple full scanning triggers, including but limited to automatic trigger each period of time or for each distance driven. The system also offers voice command full scanning trigger, floating button trigger, button as full scanning trigger, touching the touchscreen on the desired to be scanned element. In this vehicle example we are using the automatic scanning where full scanning is triggered each 0.1 second on the camera or the camera's screen.

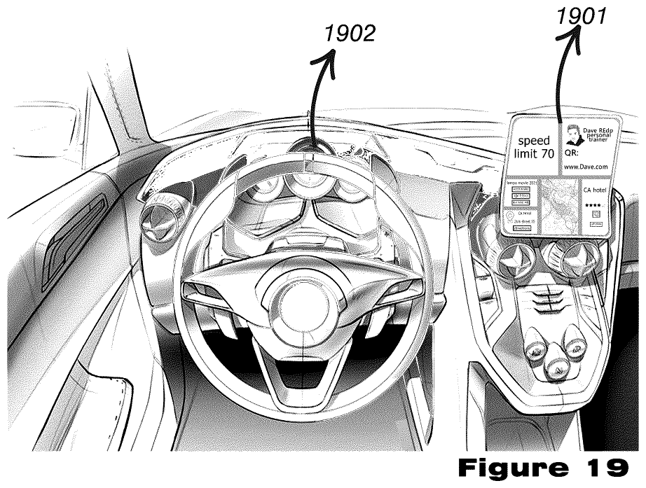

FIG. 19 explain what happens when the system was triggered to scan the signs on the road in FIG. 18 where the system automatically led to a process of decreasing the speed of the vehicle 1902 to 70 as show in the sign 1803. The system also displayed other scanning results and also results of processes made on those scanning results on the screen 1901.

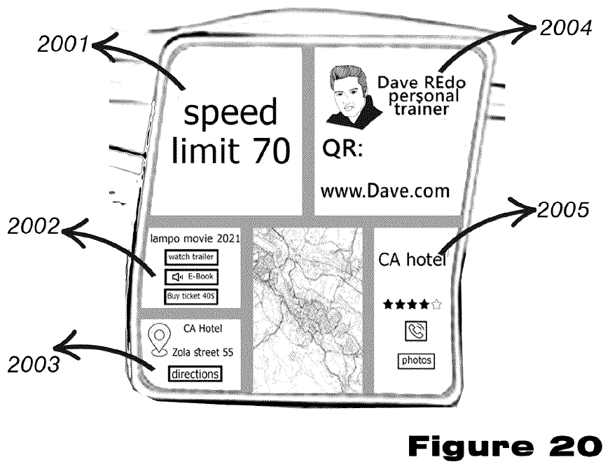

FIG. 20 is showing the screen from 1901. Scanning the speed limit sign 1803 led also to displaying that sign in words. Scanning the movie sign 1806 led to the result 2002. Scanning the location sign 1805 led to a process where the system automatically have shown the map of that location on the screen and suggested directions 2003. The system also have collected ratings given by users about this scanned location and presented them with contact information and hands-free calling option 2005. Scanning the face and QR code sign 1804 led to the identification of the person and the QR code, and were then presented on the screen 2004.

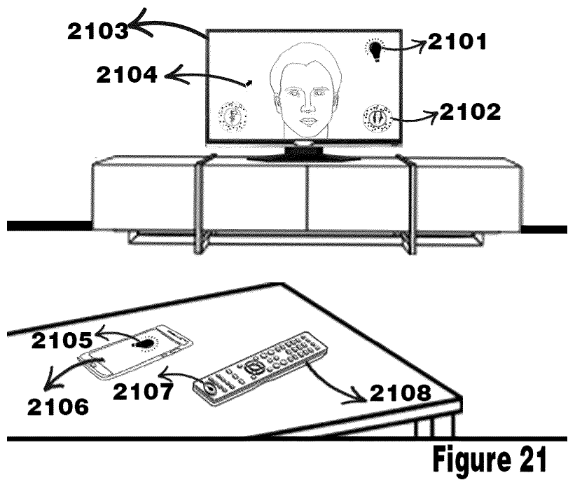

Scamote: A system and method that perform a full scanning process on a screen of a computerized device like a smart TV screen using another remote control computerized device like a smartphone or remote control without using a camera or detector. The system works by giving a full scanning command from one device (remote control device) to scan the screen of another device (has a screen). A screenshot will be taken (from the screen targeted for scanning) and the system will perform full scanning on that screenshot and perform any process or processes then present the scanning and the processes results on one or both devices screens. The system is able to perform processes based on the scanning results or processes results like suggesting other processes. The system can also perform full scanning on both of the devices screens. An example of how full scanning on a screen is triggered by another remote device is explained in FIG. 21.

Turning to FIG. 21, a screen 2103 that is connected to multiple devices such as a remote control 2108 and/or a smart phone 2106. The screen is showing multiple scannable elements such as a QR code 2102, another qr code and multiple faces. The user can trigger full scanning on the screen 2103 using a scanning button 2107 on the remote control 2108 or using a scanning floating button 2105 or another button on the smartphone 2106 or by any triggering command (such as voice command) given to the system applied to the screen through the remote control or the smartphone or directly to the screen. The user can also select a precise location for scanning also using any available input selecting devices (or from the same devices like by giving a voice command on the screen 2103 or by triggering a full scanning command on that screen 2103 by a certain hand motion of the user that is detectable by a motion detector or a camera connected with the screen 2103) like an air mouse that has control over the arrow on the screen 2104 and/or a floating button 2101 on the screen itself or any screen location selecting method available (through available input devices and methods) such as controlling the floating button on the screen 2101 with the floating button on the touchscreen 2105. The system is able to present the scanning results on the scanned screen itself 2103 or on other devices such as a smartphone display screen 2106 that is connected to the screen.

1. A method for scanning, comprising:
a) scanning, using a computerized device:
i) an article of manufacture including a media file; and
ii) wherein the media file includes at least one of: an image, a picture, a video file, a live stream video, an audio file, a post, a face, a body, a body part, and a text document.

2. The method of claim 1, wherein the article of manufacture is a device screen.

3. The method of claim 1, further comprising:
a) scanning at least one of: hashtags, shapes, symbols, faces, facial expressions, body parts, drawings, QR codes, barcodes, color, images, letters, numbers, mathematical equations, and signatures.

4. The method of claim 1, further comprising:
a) identifying at least one of: presence, attributes, location, type, position, and size of a scannable element; and
b) triggering a process based on the identification.

5. The method of claim 1, further comprising:
a) providing a scanning process that interacts with one or more devices to detect generated recognizable elements for connected items.

6. The method of claim 1, further comprising:
a) initiating a full scanning process;
b) capturing a screenshot from at least one of: a first device screen and a second device screen;
c) performing an initial scan before or after cropping the captured screenshot or image; and
d) subjecting the cropped screenshot to additional scanning processes.

7. The method of claim 1, further comprising:
a) initiating the scanning process using at least one of: voice commands, physical buttons, floating buttons, clicks, touch, movement sensation, and preset movements of a device.

8. The method of claim 1, further comprising:
a) scanning, automatically, at least one of: periodic intervals, specific times, and upon the occurrence of certain events.

9. The method of claim 1, further comprising:
a) processing each item entering the system to provide user-friendly methods for subsequent scanning.

10. The method of claim 1, further comprising:
a) scanning multiple scannable objects using a detecting device, wherein the detecting device includes at least one of: screens, cameras, scanners; and
b) executing processes based on the results of the scanning.

11. The method of claim 1, further comprising:
a) automating interactions between a user and a system;
b) providing notifications post-scanning, and
c) arranging scanning results based on user preferences.

12. The method of claim 1, further comprising:
a) scanning elements from at least one of: continuous, streaming, movable, and static objects;
b) detecting elements from at least one of: continuous, streaming, movable, and static objects;
c) counting the detected elements;
d) performing a sorting process based on the counted element; and
e) enhancing scanning, via an automatic process or via user input.

13. The method of claim 1, further comprising:
a) capturing an image using at least one of: a camera, screen, and a sensor;
b) cropping the captured image for targeted scanning; and focusing on specific regions of the captured image before scanning.

14. The method of claim 1, further comprising:
a) recognizing an element, wherein the element includes at least one of: faces, facial expressions, bodies, body parts, writings, shapes, symbols, QR codes, barcodes, drawings, signatures, and mathematical equations;
b) processing the element;
c) comparing the scanned results;
d) organizing the scanned results;
e) differentiating the scanned results; and
f) sorting the scanned results.

15. The method of claim 1, further comprising:
a) scanning uploaded items, wherein the uploaded items include at least one of: intellectual property marks, numbers, names, symbols, shapes, detectors, codes, letters, and faces;
b) checking the scanned uploaded items;
c) alerting at least one of: a user and a rights holder.

16. The method of claim 1, further comprising:
a) offering full scanning; and
b) automatically enhancing the quality of scannable objects.

17. The method of claim 1, further comprising:
a) initiating one or more full scanning triggers;
b) detecting multiple elements including at least one of: phone numbers, shapes, faces, products, signs, texts, and QR codes;
c) offering user-specific actions based on the detected elements; and
d) generating identifiable marks for each item uploaded to the system for a purpose including at least one of: intellectual property protection, tracing, and tracking.

18. The method of claim 1, further comprising:
a) ingesting new scannable elements;
b) storing the scannable elements into memory for future reference, wherein the scannable elements include at least one of: signatures, face landmarks, symbols, shapes, drawings, pictures, photos, and colors.

19. The method of claim 1, further comprising:
a) automating or manually triggering a scanning process;
b) capturing current screen data for at least one of: a first device and a second device;
c) requesting a scanning application programming interface for processing;
d) dividing results into detectors of smaller identifiable elements and fully identified elements; and
e) repetitively enhancing the scanning process until all elements are identified.

20. A method for scanning, comprising:
a) scanning, using a computerized device:
i) an article of manufacture including at least one small scannable element.
